(19) United States
(12) Patent Application Publication
(10) Pub. No.: US 2009/0222587 A1
(43) Pub. Date: Sep. 3, 2009

(54) Providing location path

(75) Inventors: Byung-Ik Ahn, Seongnam (KR); Won-Tae Kim, Yongin (KR); Myoung-Jin Shin, Seoul (KR)

Correspondence Address: HARNESS, DICKEY & PIERCE, P.L.C., P.O. BOX 828, BLOOMFIELD HILLS, MI, 48303, US

(73) Assignee: POINT-I Co., Ltd.

(21) Appl. No.: 12/156,566

(22) Filed: Jun. 3, 2008

(30) Foreign Application Priority Data
Feb. 28, 2008 (KR) 10-2008-0018243

(51) Int. Cl. G06F 15/16

(52) U.S. Cl. 709/246

(57) ABSTRACT

The server for providing location path, comprising: a server communication unit for interlocking with a mobile communication terminal and an E-mail reception server; a server control unit for receiving location path data and E-mail account information from the mobile communication terminal by controlling the server communication unit, creating location tracking data converted to a data format, which is supported by at least one or more predetermined navigation program, from the location path data, and transmitting the location tracking data to the E-mail reception server corresponding to the E-mail account information by controlling the server communication unit; and a server storage unit for storing at least one of the location path data, the E-mail account information, and the location tracking data.

### CROSS-REFERENCE TO RELATED APPLICATION

This non-provisional application claims priority under 35 U.S.C §119(a) on Patent Application No. 10-2008-0018243 filed in Korea on Feb. 28, 2008, the entire contents of which are hereby incorporated by reference.

### BACKGROUND OF THE INVENTION

1. Field of the invention

The present invention relates generally to technology for providing a location path of a user to computers of the user.

2. Description of the Prior Art

A mobile carrier which operates a mobile communication system and provides a variety of supplementary services traces a location of a mobile communication terminal using triangulation, and provides a variety of location-based services based on the traced mobile communication terminal.

However, a common method for providing a location-based service by means of base stations can just measure approximately a location of a mobile communication terminal, and cannot measure precisely the location of the mobile communication terminal. A location tracking system using a global positioning system is introduced as a solution to the problem of the common method.

The above mentioned global positioning system is developed by the pentagon in the early 1970's and has been in operation since the middle of 1990's. The global positioning system is the most ideal navigation system available across the globe regardless of time or weather conditions. Although developed for military, nowadays the global positioning system has been the most common navigation system due to economic efficiency and usefulness.

For example, a variety of mobile objects such as a ship, a aircraft, a vehicle or the like is equipped with a global positioning system assist positioning device for detecting a current location and a moving speed and determining a moving path. The global positioning system assist positioning device receives a radio wave representing latitude and longitude from three or more satellites located in six middle earth orbits, and calculates a current location of mobile objects. The calculated result is displayed on a navigation device.

Therefore, the navigation device joins the current location of the mobile objects to an already stored map, so that the navigation device can provide not only the current location of the mobile objects but also a variety of information needed for traveling such as a progress direction of the mobile objects, a distance to destination of the mobile objects, a current speed of the mobile objects, a path set by a user before moving, road information, a recommended path to destination or the like.

Meanwhile, a traditional location-based service is provided as a navigation service which combines a location of a mobile communication terminal equipped with an external global positioning system module with geographical information, area information or the like and then provides. However, recently a mobile carrier has introduced some positioning solutions and has provided a location-based service using the positioning solutions, wherein the location-based service is being utilized in various application service of finding a friend, providing area information, etc. Also, recently ‘Naviphone’ type of mobile communication terminals equipped with the global positioning system module are mostly released However, additional software is necessary to receive navigation data from satellite and display the navigation data, in spite of the ‘Naviphone’ type of navigation terminals or mobile communication terminals equipped with a global positioning system module. In other words, if location data of a user is stored into a mobile communication terminal or a mobile communication terminal, the stored location path data can be read and displayed by only the same software as the software installed on the mobile communication terminal or the navigation terminal.

However, because most of common software installed in the navigation terminal or the mobile communication terminal equipped with the global positioning system module cannot be installed in common personal computers, there is a problem, in that a user should use only the navigation terminal or the mobile communication terminal which created the location path in order to identify the stored location path.

### SUMMARY OF THE INVENTION

Accordingly, the present invention has been made to solve the above-mentioned problem occurring in the prior art, and an object of the present invention is to provide a method, a system and a server for providing a location path to a user, wherein if a user transmits a location path to a specific E-mail account by means of a mobile communication terminal, a server converts the location path to a data format supported by at least one or more predetermined navigation program and transmit the location path to a E-mail reception server, and the user receives the location path attached to the specific E-mail account from the E-mail reception server by means of a user terminal such as a common personal computer instead of the mobile communication terminal and display and identify the location path using a navigation program installed on the user terminal.

In accordance with an aspect of the present invention, there is provided a server for providing a location path, comprising: a server communication unit for cooperating with a mobile communication terminal and an E-mail reception server; a server control unit for controlling the server communication unit to receive location path data and E-mail account information from the mobile communication terminal, creating location tracking data converted to a data format supported by at least one or more predetermined navigation program from the location path data, and controlling the server communication unit to transmit the location tracking data to the E-mail reception server corresponding to the E-mail account information; and a server storage unit for storing at least one or more of the location path data, the E-mail account information, and the location tracking data.

In accordance with another aspect of the present invention, there is provided a system for providing a location path, comprising: a location tracking server for receiving location path data and E-mail account information, creating location tracking data converted to a data format supported by at least one or more predetermined navigation program from the received location path data, and transmitting the location tracking data using the E-mail account information; an E-mail reception server for receiving the location tracking data from the location tracking server, and transmitting the location tracking data when a transmission request signal for the location tracking data attached to the E-mail account information is received; a user terminal for receiving the location tracking data, and displaying the location tracking data using the at least one or more predetermined navigation program; and an internet for relaying a transmitting/receiving data between the E-mail reception server and the user terminal.

In accordance with another aspect of the present invention, there is provided a method for providing a location path, comprising the step of: receiving location path data and E-mail account information from a mobile communication terminal at a location tracking server; creating location tracking data converted to a data format supported by at least one or more predetermined navigation program from the location path data at the location tracking server; transmitting the location tracking data using the E-mail account information at the location tracking server; receiving and storing the location tracking data at an E-mail reception server; checking whether a transmission request signal for the location tracking data attached to the E-mail account information is received or not at the E-mail reception server; transmitting the location tracking data, if the transmission request signal for the location tracking data is received, at the E-mail reception server; and receiving the location tracking data, and displaying the location tracking data by means of the at least one or more predetermined navigation program at a user terminal.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a system for providing a location path according to an exemplary embodiment of the present invention;

FIG. 2 is a block diagram illustrating a server for providing the location path according to the exemplary embodiment of the present invention;

FIG. 3 is a flowchart illustrating a method for providing the location path according to the exemplary embodiment of the present invention;

FIG. 4 is a view illustrating a method of transmitting the location path data via E-mail according to the exemplary embodiment of the present invention;

FIG. 5 is a view illustrating a method of the user's displaying the location path data via E-mail according to the exemplary embodiment of the present invention; and

FIG. 6 is a view illustrating the navigation program according to the exemplary embodiment of the present invention.

### DETAILED DESCRIPTION OF THE EXEMPLARY EMBODIMENTS

Hereinafter, an exemplary embodiment of the present invention will be described with reference to the accompanying drawings. In the following description and drawings of the present invention, the same reference numerals are used to designate the same or similar components, and the detailed description of known functions and configurations incorporated herein is omitted to avoid making the subject matter of the present invention unclear.

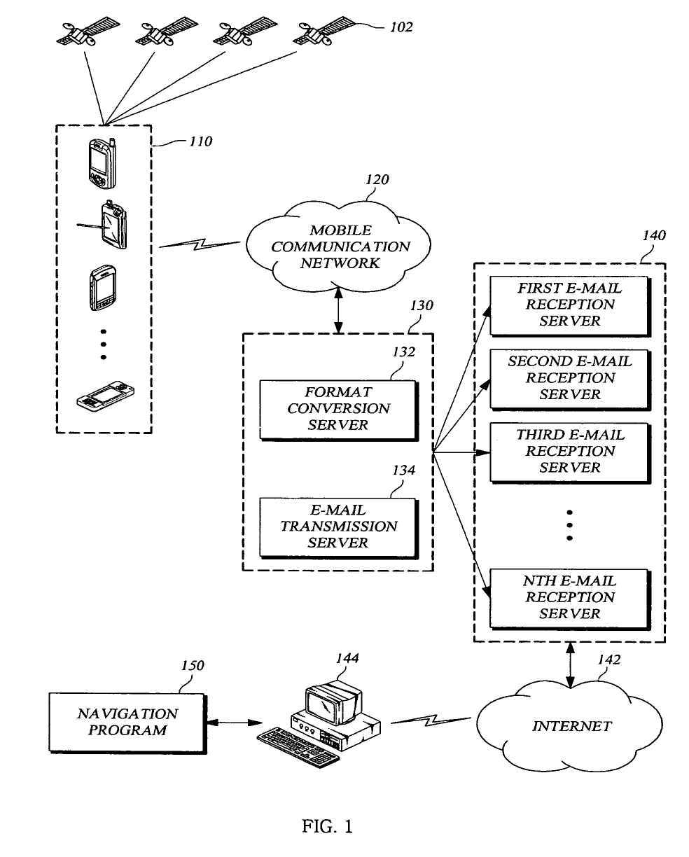

FIG. 1 is a block diagram illustrating a system for providing a location path according to an exemplary embodiment of the present invention.

The system for providing a location path according to the exemplary embodiment of the present invention includes a satellite 102, a mobile communication terminal 110, a mobile communication network 120, a location tracking server 130, an E-mail reception server 140, the internet 142, a user terminal and a navigation program 150.

The satellite 102 comprises one or more global positioning system satellites, and transmits navigation data which includes latitude and longitude coordinates to the mobile communication terminal 100.

The mobile communication terminal 110 is a terminal which performs typical voice communication and data communication wirelessly in cooperation with the mobile communication network 120.

The mobile communication terminal 110 can be a personal digital assistant, a cellular phone, a personal communication service phone, a hand-held personal computer, a code division multiple access-2000 phone, a wideband code division multiple access phone, a portable multimedia player, a play station portable, a mobile broadband system phone, a navigation terminal and the like.

Also, the mobile communication terminal 110 according to the exemplary embodiment of the present invention is a terminal equipped with a global positioning system module (not shown), receives navigation data from the satellite 102 by means of the global positioning system module, and calculates a current location.

Herein, for the convenience of explanation, it is explained that the mobile communication terminal 110 receives the navigation data from the satellite 102 and calculates the current location. However, that is only an illustration of the present invention and the mobile communication terminal 110 can transmit the navigation terminal received from the satellite 102 to a location calculation server (not shown), can receive current location information calculated by the location calculation server, and can display the current location information.

The mobile communication terminal 110 according to the exemplary embodiment of the present invention creates location path data when a specific destination is input, and transmits the location path data and E-mail account information to the location tracking server 130 when an E-mail transmission request signal for the location path data is received.

The mobile communication network 120 is wirelessly connected with the mobile communication terminal 110, and performs the various functions of a voice communication service, a wireless data service, a wireless internet service, a video call service, a video message service or the like.

The location tracking server 130 according to the exemplary embodiment of the present invention receives the location path data and the E-mail account information from the mobile communication terminal 110, creates the location tracking data converted to a data format supported by at least one or more predetermined navigation program, and transmits the location tracking data to the E-mail reception server 140 corresponding to the E-mail account information.

Herein, the at least one or more predetermined navigation program is set by a manufacturer or set by the operation or instruction of a user.

Although the FIG. 1 is illustrated and the description of the FIG. 1 is explained as if the location tracking server 130 comprises a format conversion server 132 and an E-mail transmission server 134, that is only an illustration of the present invention. In other words, the format conversion server 132 and the E-mail transmission server 134 can be configured as an independent server respectively, or only one server, which includes the function of the format conversion server 132 and the E-mail transmission server 134 as well as the function of the location tracking server 130, can be configured as the location tracking server 130.

The format conversion server 132 creates the location tracking data converted to a data format supported by the at least one or more predetermined navigation program from the location path data received from the mobile communication terminal 110.

The E-mail transmission server 134 receives the location tracking data from the format conversion server 132, and transmits the location tracking data to the E-mail reception server 140 corresponding to the E-mail account information received from the mobile communication terminal 110.

The E-mail reception server receives the location tracking data from the location tracking server 130, and transmits the location tracking data to the user terminal 144 when the transmission request signal for the location tracking data attached to the E-mail account information is received from the user terminal 144.

The internet 142 is a network capable of transmitting and receiving data by means of internet protocol using wired/wireless communication scheme, and relays transmitting/receiving data between the E-mail reception server 140 and the user terminal 144.

The user terminal 144 is a terminal capable of receiving a variety of web page data via the internet 142 in accordance with the key operation of a user, may be one of a personal computer, a laptop computer, a personal digital assistant, a mobile communication terminal or the like, and may be a terminal equipped with a memory for storing a web browser and a program to connect the E-mail server 140 via the internet 142 and a microprocessor for calculating and controlling by prosecuting the program.

The user terminal 144 receives the location tracking data from the E-mail reception server 140, and displays the location tracking data using the navigation program 150.

The navigation program 150 means a kind of map program for displaying the location tracking data on a map in cooperation with the user terminal 144. For example, the navigation program 150 may be a map program for displaying three-dimensionally not only overall round figure of the earth but also the form of terrain and the city's buildings when enlarged, can turn and view the earth or can enlarge a specific area. The map data used by the navigation program 150 can be implemented in forms of two-dimension or three-dimension, and can inform high and low by numbers or colors.

Also, the navigation program 150 can display area information and location (or distance) information using the function of zooming in and zooming out, can search a hotel, a restaurant, a drive course, etc, or can store the search result in a folder or share the search result with others. And the navigation program 150 can display primary structures such as a park, a school, a hospital, an airport or the like. Therefore, a user can use the navigation program 150 for planning a trip, finding the shortest distance for a drive, finding a house or an apartment, a business trip, a world travel or the like.

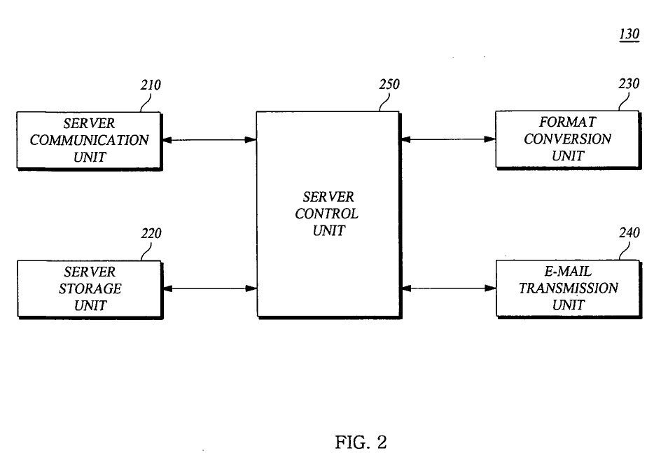

FIG. 2 is a block diagram illustrating a server for providing the location path according to the exemplary embodiment of the present invention.

The server for providing the location path according to the exemplary embodiment of the present invention includes a server communication unit 210, a server storage unit 220, a format conversion unit 230, an E-mail transmission unit 240 and a server control unit 250.

Although the FIG. 2 is illustrated and the description of the FIG. 2 is explained as if the server for providing the location path according to the exemplary embodiment of the present invention comprises only the server communication unit 210, the server storage unit 220, the format conversion unit 230, the E-mail transmission unit 240 and the server control unit 250, that is only an illustration of the present invention. In other words, the server for providing the location path according to the exemplary embodiment of the present invention can comprises a variety of elements.

The server communication unit 210 is a communication means for cooperating with the mobile communication terminal 110 and the E-mail reception server 140 via the internet 120, and transmits and receives a variety of data.

The server storage unit 220 is a storage means for storing a variety of data needed for driving a server, and stores at least one or more the E-mail account information and the location tracking data.

The format conversion unit 230 creates the location tracking data converted to the data format supported by the at least one or more predetermined navigation program from the location path data received from the mobile communication terminal 110.

The E-mail transmission unit 240 receives the location tracking data from the format conversion unit 230, and transmits the location tracking data to the E-mail reception server 140 corresponding to the E-mail account information received from the mobile communication terminal 110.

The format conversion unit 230 and the E-mail transmission unit 240 illustrated in FIG. 2 are devices of performing the same function as the function of the format conversion server 132 and the E-mail server 134 respectively.

The server control unit 250 according to the exemplary embodiment of the present invention is a control means for controlling an overall function of a server. The server control unit 250 controls the server communication unit 210 to receive the location path data and the E-mail account information from the mobile communication terminal 110, the format conversion unit 230 to create the location tracking data converted to the data format supported by the at least one or more predetermined navigation program from the location path data, and the E-mail transmission unit 140 to transmit the location tracking data to the E-mail reception server 140 corresponding to the E-mail account information.

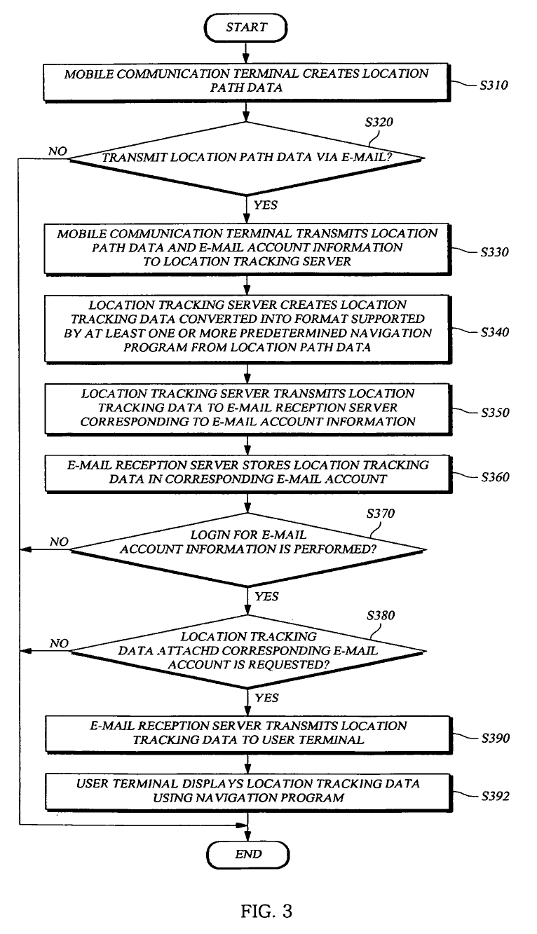

FIG. 3 is a flowchart illustrating a method for providing the location path according to the exemplary embodiment of the present invention.

The mobile communication terminal 110 receives the navigation data from the satellite 102 using the equipped global positioning system module, calculates the current location, and creates the location path data from the current location to a specific destination when the specific destination is input at step 310.

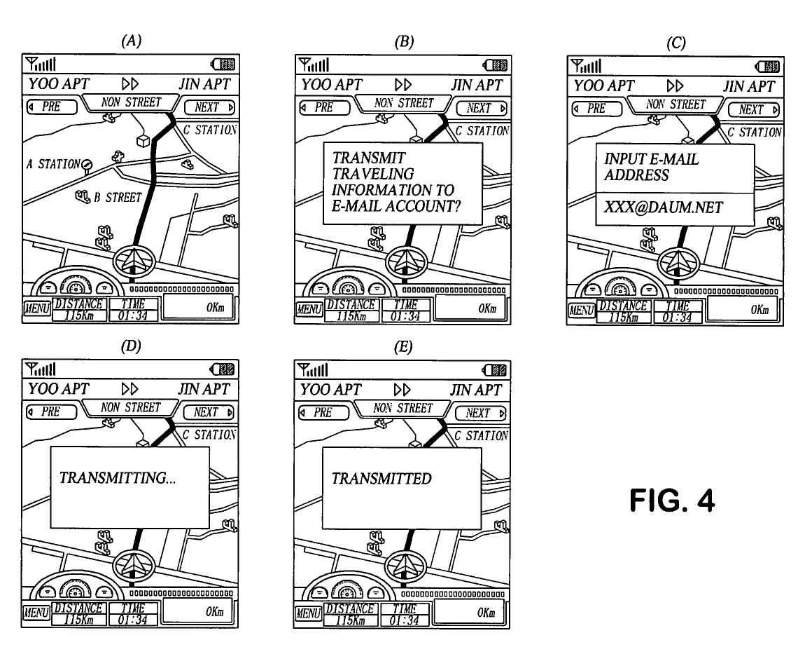

The mobile communication terminal 110 checks whether or not to transmit the location path data via E-mail at step 320. For instance, as shown in FIG. 4(A), a user can input the specific destination operating the mobile communication terminal 110 and then set a location path. Also, as shown in FIG. 4(B), the mobile communication terminal 110 checks whether or not to transmit the location path data via E-mail.

As a result of checking at the step 320, in case of transmitting the location path data via E-mail, the E-mail account information is input into the mobile communication terminal 110 by the operation or instruction of a user and the mobile communication terminal 110 transmits the set location path data and the E-mail account information to the location tracking server 130 via the mobile communication network 120 at step 330.

For example, if a user input the E-mail account information ‘xxx@daum.net’ to the mobile communication terminal 110 as shown in FIG. 4(C), the mobile communication terminal 110 transmits the E-mail account information and the location path data to the location tracking server 130 as shown in FIG. 4(D) to (E).

The location tracking server 130 creates the location tracking data by converting the location path data into the data format by the at least one or more navigation program supported at step 340. The location tracking server 130 transmits the location tracking data to the E-mail reception server 140 corresponding to the E-mail account information at step 350.

The E-mail reception server 140 receives the location tracking data from the location tracking server 130, and stores the location tracking data in connection with the corresponding E-mail account at step 360. The E-mail server 140 checks whether a login with regard to the E-mail account information is performed or not at step 370.

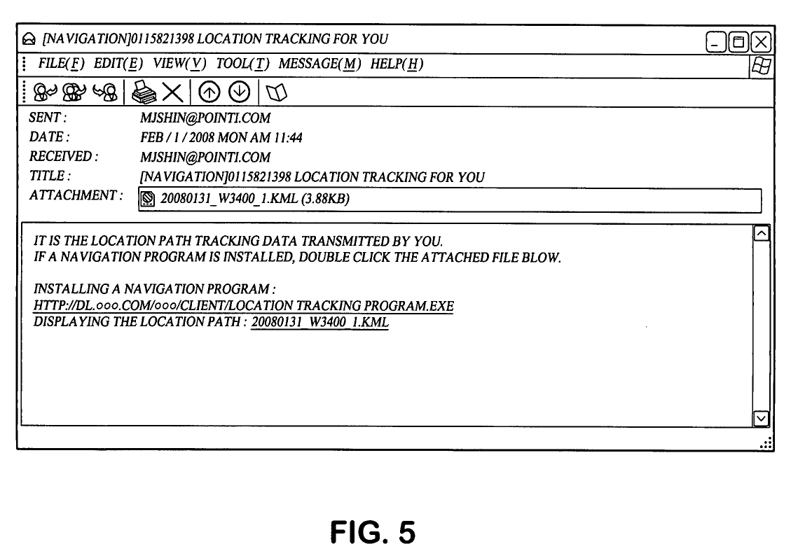

As a result of checking at the step 370, in case of the login with regard to the E-mail account information being performed, the E-mail reception server 140 checks whether the transmission request signal for the location tracking data attached the corresponding E-mail account is received from the user terminal 144 or not at step 380. For example, when the user selects the corresponding E-mail after connecting the E-mail server 140 via the internet 142 and logging in the E-mail account by operating the user terminal 144, the contents of the E-mail sent by the user are displayed as shown in FIG. 5.

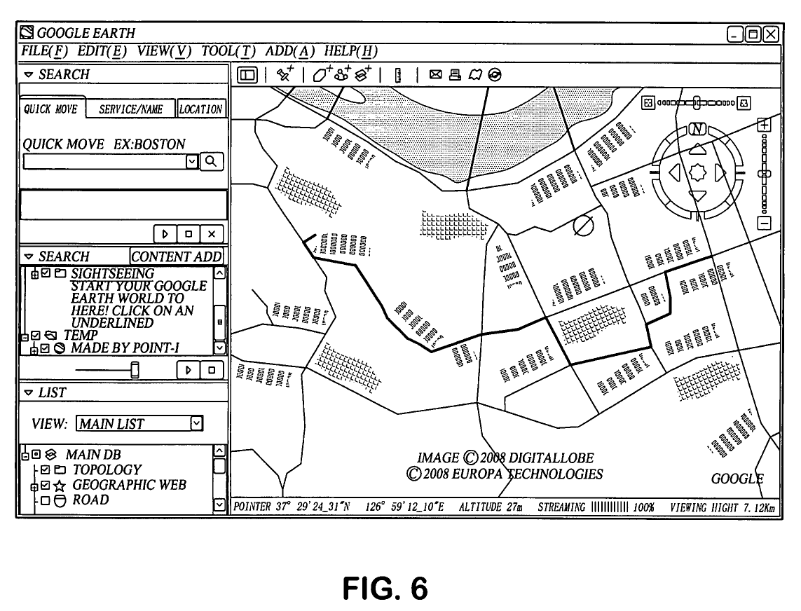

A user can download the navigation program 150 from a program providing server (not shown) by means of hyperlink and can install the navigation program into the user terminal 142 by selecting the ‘installing a navigation program’, as shown in FIG. 5. If the navigation program is installed into the user terminal 142, a user can display the location tracking data by means of the installed navigation program 150 as shown in FIG. 6 by selecting the ‘displaying a location path’ as shown in FIG. 5 As a result of checking at the step 380, when the transmission request signal for the location tracking data attached to the corresponding E-mail account is received, the E-mail reception server transmits the location tracking data to the terminal 144 at step 390.

The user terminal 144 displays the location tracking data by means of the navigation program 150 at step 392.

According to the present invention as described above, a user can be delivered location information acquired during walking, climbing, jogging or the like via E-mail.

Also, according to the present invention, a user can easily share the location information with others or peoples who need protection such as children, the week, the elderly or the like.

Also, according to the present invention, a user can store and manage the user's own path information such as a path up a mountain, a jogging course or the like by means of a user terminal.

The spirit of the present invention has been described above for illustrative purposes, it is understood by those skilled in the art to which the present invention belongs that various changes and modifications in forms and details may be made therein without departing from the essential characteristics of the present invention. Accordingly, disclosed embodiments of the present invention are not intended to limit but intended to describe the spirit of the present invention. The spirit of the present invention is not limited to such embodiments. The protecting range of the present invention is to be construed according to the appended claims and it should be construed that every technical spirit within ranges equivalent to the claims are included in the scope of the present invention.

What is claimed is:

1. A server for providing a location path, comprising:
a server communication unit for cooperating with a mobile communication terminal and an E-mail reception server;
a server control unit for controlling the server communication unit to receive location path data and E-mail account information from the mobile communication terminal, creating location tracking data converted to a data format supported by at least one or more predetermined navigation program from the location path data, and controlling the server communication unit to transmit the location tracking data to the E-mail reception server corresponding to the E-mail account information; and
a server storage unit for storing at least one or more of the location path data, the E-mail account information, and the location tracking data.

2. The server of claim 1, further comprising: a format conversion unit for creating the location tracking data converted to the data format supported by the at least one or more predetermined navigation program from the location path data, wherein the server control unit controls the format conversion unit to create the location tracking data.

3. The server of claim 1, further comprising: an E-mail transmission unit for transmitting the location tracking data to the E-mail reception server corresponding to the E-mail account information, wherein the server control unit controls the E-mail transmission unit to transmit the location tracking data.

4. A system for providing a location path, comprising:
a location tracking server for receiving location path data and E-mail account information, creating location tracking data converted to a data format supported by at least one or more predetermined navigation program from the received location path data, and transmitting the location tracking data using the E-mail account information;
an E-mail reception server for receiving the location tracking data from the location tracking server, and transmitting the location tracking data when a transmission request signal for the location tracking data attached to the E-mail account information is received;
a user terminal for receiving the location tracking data, and displaying the location tracking data using the at least one or more predetermined navigation program; and
an internet for relaying a transmitting/receiving data between the E-mail reception server and the user terminal.

5. The system of claim 4, further comprising:
a mobile communication terminal for receiving navigation data from a satellite by means of an equipped global positioning system module, calculating a current location, creating the location path data from the current location to a specific destination when the specific destination is input, and transmitting the location path data and the E-mail account information to the location tracking server when an E-mail transmission request signal for the location path data is received; and
a mobile communication network for relaying transmitting/receiving data between the location tracking server and the mobile communication terminal.

6. A method for providing a location path, comprising the step of:
receiving location path data and E-mail account information from a mobile communication terminal at a location tracking server;
creating location tracking data converted to a data format supported by at least one or more predetermined navigation program from the location path data at the location tracking server;
transmitting the location tracking data using the E-mail account information at the location tracking server;
receiving and storing the location tracking data at an E-mail reception server;
checking whether a transmission request signal for the location tracking data attached to the E-mail account information is received or not at the E-mail reception server;
transmitting the location tracking data, if the transmission request signal for the location tracking data is received, at the E-mail reception server; and
receiving the location tracking data, and displaying the location tracking data by means of the at least one or more predetermined navigation program at a user terminal.
